(19) United States
(12) Patent Application Publication
(10) Pub. No.: US 2024/0316790 A1
(43) Pub. Date: Sep. 26, 2024

(54) Underwater Manipulator

(71) Applicant: GUANGDONG OCEAN UNIVERSITY, Zhanjiang (CN)

(72) Inventors: Ji Wang, Zhanjiang (CN); Yitong LI, Zhanjiang (CN)

(21) Appl. No.: 17/927,115

(22) PCT Filed: Aug. 17, 2022
(86) PCT No.: PCT/CN2022/112896

§ 371 Date: Nov. 22, 2022

(30) Foreign Application Priority Data
Mar. 1, 2022 (CN) 202210189037.8

(51) Int. Cl. B25J 15/00; B25J 9/10; B63G 8/00

(52) U.S. Cl. CPC B25J 15/0033; B25J 9/102; B63G 8/001; B63G 2008/004

(57) ABSTRACT

An underwater manipulator that includes a mounting disc which is connected with a lifting part configured for controlling the mounting disc to ascend and descend; and a driving part configured for controlling the mounting disc to move horizontally; a manipulator main body fixedly arranged on one side of the mounting disc; and a plurality of mechanical claws slidably connected with an interior of the manipulator main body, where each mechanical claw is controlled by a control part to rotate. Lifting of the mounting disc is directly controlled through the lifting part, and the mounting disc is driven by the driving part to move in a certain plane in water, so that the manipulator can randomly move in a specific range and can move for a long distance, and the limitation of a water ship body or an underwater robot on the manipulator is reduced.

### CROSS-REFERENCE TO RELATED APPLICATIONS

This application is a national stage of International Application No. PCT/CN2022/112896, filed on Aug. 17, 2022, which claims priority to Chinese Patent Application No.202210189037.8, filed on Mar. 1, 2022. Both of the aforementioned applications are hereby incorporated by reference in their entireties.

### TECHNICAL FIELD

The present disclosure relates to the technical field of manipulators, particularly to an underwater manipulator.

### BACKGROUND

The ocean is rich in biological resources, mineral resources, petroleum, coal, natural gas and other energy sources. Utilization and development of oceans are important for many countries, and a large amount of capital, manpower and material resources are invested in the field of research. The status of ocean resource development, ocean environment climate research, inland water transportation, water resource utilization and the like in national economy determines important significance in developing underwater technologies and underwater operation systems. Various kinds of underwater robots are consistently recognized by ocean scientists as the most important basic technology for developing ocean resources. The underwater robot can be widely applied to many aspects such as seabed mineral resource development, marine salvage, ocean investigation, underwater engineering construction, military and national defense construction.

The manipulator is an automatic operation device which can simulate certain action functions of human hands and arms and is used for grabbing and carrying objects or operation tools according to a fixed program. However, all existing underwater manipulators need to be attached to an underwater robot or a water ship body for short-distance operation. The manipulator moves through movement of an underwater robot or movement of a water ship body, and the manipulator cannot move for a long distance, so that the working range of the manipulator is limited. Moreover, the existing manipulator is too complex in function and structure and too high in manufacturing cost.

### SUMMARY

An object of the present disclosure is to provide an underwater manipulator so as to solve the problems in the prior art.

In order to achieve the object, the present disclosure provides the following solution.

It is provided an underwater manipulator. The underwater manipulator includes: a mounting disc connected with a lifting part configured for controlling the mounting disc to ascend and descend, and a driving part configured for controlling the mounting disc to move horizontally; a manipulator main body fixedly arranged on a side of the mounting disc; and a plurality of mechanical claws slidably connected with an interior of the manipulator main body, wherein each mechanical claw is controlled by a control part to rotate.

In some embodiments, the lifting part includes an expansion ball body fixedly connected with the mounting disc. The expansion ball body is communicated with a gas pipe, the gas pipe is fixedly connected with a limiting mooring rope, and an end of the gas pipe and an end of the limiting mooring rope are connected with a water ship body or an underwater robot.

In some embodiments, the mounting disc includes an upper fixed disc and a lower connecting disc which are fixedly connected. The manipulator main body and the expansion ball body are fixedly connected with the upper fixed disc, and the gas pipe and the limiting mooring rope are fixedly connected with the lower connecting disc.

In some embodiments, a rotating shaft is rotatably connected between the upper fixed disc and the lower connecting disc. The driving part includes a driving shaft and a propeller fixedly arranged on the driving shaft, the driving shaft penetrates through the rotating shaft and is parallel to the upper fixed disc, and the driving shaft is driven by a first motor.

In some embodiments, connecting sleeves are fixedly arranged between the manipulator main body and the mounting disc, and the number of the connecting sleeves is equal to that of the plurality of mechanical claws. The control part includes rotating rods arranged in the connecting sleeves. An end of each rotating rod is connected with a transmission shaft through a bevel gear assembly. The transmission shaft is perpendicular to the rotating rod, gear teeth are arranged on outer sides of the mechanical claws, driving gears matched with the gear teeth are rotatably connected with interiors of the connecting sleeves, and the driving gears are in shaft connection with the transmission shafts.

In some embodiments, the manipulator main body is of a horizontal semicircular cylinder structure, each mechanical claw is of an arc-shaped structure matched with the semicircular cylinder structure of the manipulator main body, at least two mechanical claws are provided on two sides of the interior of the manipulator main body respectively, and the connecting sleeves are arranged on two sides of an exterior of the manipulator main body.

In some embodiments, two ends of the manipulator main body are detachably connected with end plates matched with the semicircular cylinder structure of the manipulator main body, a limiting plate is arranged on an outer side of each end plate, and a hydraulic cylinder is connected between the limiting plate and the mounting disc.

In some embodiments, the manipulator main body is of a hollow hemispherical structure, and each mechanical claw is of a three-dimensional arc-shaped structure matched with the hollow hemispherical structure of the manipulator main body.

In some embodiments, the three-dimensional arc-shaped structure of the mechanical claw is of a three-point type structure. A first end point of the mechanical claw is arranged on an uppermost portion of the mechanical claw, and a second end point and a third end point of the mechanical claw are arranged on a lowermost portion of the mechanical claw and located on a same horizontal line; and at least three mechanical claws are provided and distances between every two adjacent mechanical claws are equal one another.

In some embodiments, an elastic limiting net is arranged between each mechanical claw and the manipulator main body, an end of the elastic limiting net is provided at a highest end of the mechanical claw, and another end of the elastic limiting net is fixedly provided in the manipulator main body.

The underwater manipulator has the following beneficial effects. Lifting of the mounting disc is directly controlled through the lifting part, and the mounting disc is driven by the driving part to move in a certain plane in water, so that the manipulator can randomly move in a specific range and can move for a long distance, and the limitation of a water ship body or an underwater robot on the manipulator is reduced. The mechanical claws are driven to slide in the manipulator main body through the control part, the multiple mechanical claws work synchronously to achieve grabbing, dragging and other work, and most underwater work on the seabed can be achieved.

### BRIEF DESCRIPTION OF THE DRAWINGS

To more clearly illustrate the embodiment of the present disclosure or the technical solution in the prior art, the following briefly describes the accompanying drawings to be used in the embodiment. Apparently, the accompanying drawings in the following description show merely some embodiments of the present disclosure, and those skilled in the art may still derive other drawings from these accompanying drawings without creative efforts.

FIG. 1 is a structural schematic diagram of an underwater manipulator according to the present disclosure;

FIG. 2 is a partial structure schematic diagram of the underwater manipulator disclosed in Embodiment One according to the present disclosure;

FIG. 3 is a front view of the underwater manipulator disclosed in Embodiment One;

FIG. 4 is a partial structure schematic diagram of the underwater manipulator disclosed in Embodiment Two; and

FIG. 5 is a structural schematic diagram of a mechanical claw of the underwater manipulator disclosed in Embodiment Two.

Reference numerals: 1 mounting disc; 2 manipulator main body; 3 mechanical claw; 4 expansion ball body; 5 gas pipe; 6 limiting mooring rope; 7 underwater robot; 8 upper fixed disc; 9 lower connecting disc; 10 rotating shaft; 11 driving shaft; 12 propeller; 13 connecting sleeve; 14 rotating rod; 15 transmission shaft; 16 limiting plate; 17 hydraulic cylinder; 18 elastic limiting net; 19 driving gear; and 20 end plate.

### DETAILED DESCRIPTION OF THE EMBODIMENTS

The following clearly and completely describes the technical solution in the embodiments of the present disclosure with reference to the accompanying drawings in the embodiments of the present disclosure. Apparently, the described embodiments are merely a part rather than all of the embodiments of the present disclosure. Based on the embodiment in the present disclosure, all other embodiments obtained by the ordinary technical staff in the art without paying creative efforts belong to the scope protected by the present disclosure.

To make the foregoing objectives, features and advantages of the present disclosure clearer and more comprehensible, the present disclosure is further described in detail below with reference to the accompanying drawings and specific embodiments.

### Embodiment One

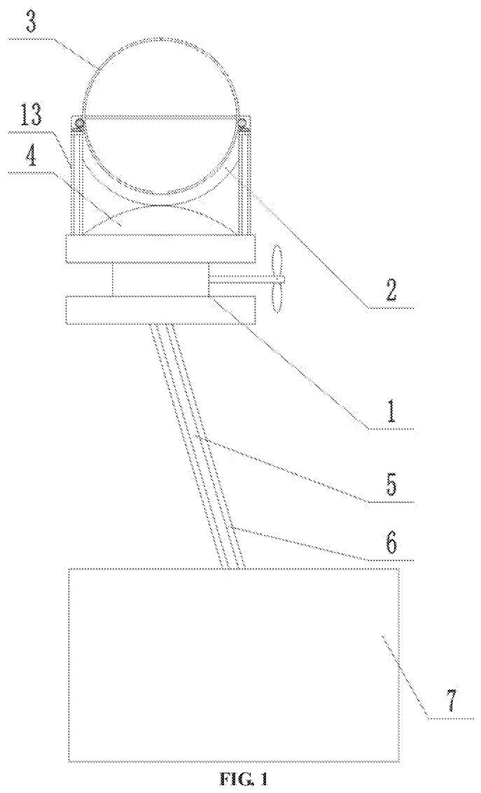

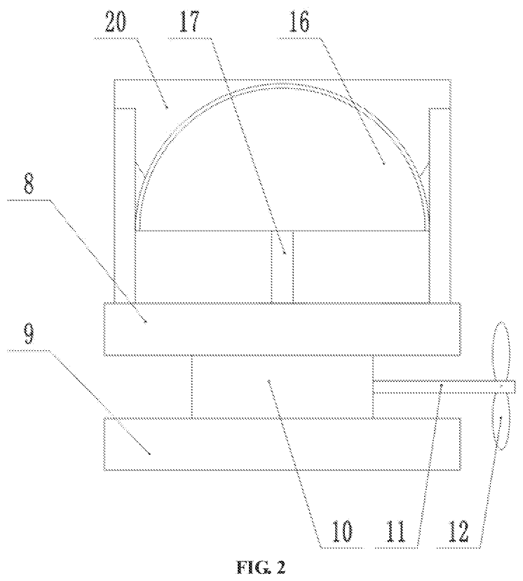

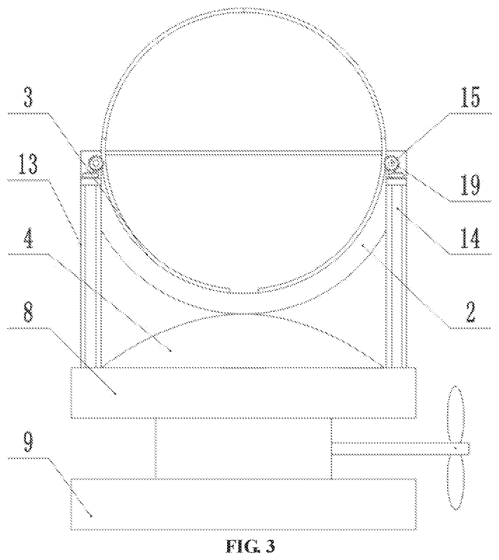

Referring to FIG. 1 to FIG. 3, the embodiment provides an underwater manipulator. The underwater manipulator includes a mounting disc 1, where the mounting disc 1 is connected with a lifting part used for controlling the mounting disc 1 to ascend and descend and a driving part used for controlling the mounting disc 1 to move horizontally; a manipulator main body 2 fixedly arranged on one side of the mounting disc 1; and a plurality of mechanical claws 3 slidably connected with an interior of the manipulator main body 2, where each mechanical claw 3 is controlled by a control part to rotate. Lifting of the mounting disc 1 is directly controlled through the lifting part, and the mounting disc 1 is driven by the driving part to move in a certain plane in water, so that the manipulator can randomly move in a specific range and can move for a long distance, and limitation of a water ship body or an underwater robot 7 on the manipulator is reduced. The mechanical claws 3 are driven to slide in the manipulator main body 2 through the control part, the plurality of mechanical claws 3 work synchronously to achieve grabbing, dragging and other work, and most underwater work on the seabed can be achieved.

Through further optimization solution, the lifting part includes an expansion ball body 4 fixedly connected with the mounting disc 1, the expansion ball body 4 is communicated with an gas pipe 5, the gas pipe 5 is fixedly connected with a limiting mooring rope 6, and an end of the gas pipe 5 and an end of the limiting mooring rope 6 are both connected with a water ship body or an underwater robot 7. The lengths of the gas pipe 5 and the limiting mooring rope 6 are controlled according to actual requirements, to limit operation and motion range of the manipulator. The limiting mooring rope 6 is of an elastic sealing structure and of a hollow structure, the gas pipe 5 is arranged in the limiting mooring rope 6 so that extrusion effect of underwater pressure on the gas pipe 5 is reduced. Gas is filled into or pumped out of the gas pipe 5 through the water ship body or the underwater robot 7 to control a volume of the expansion ball body 4, so that the overall buoyancy of the manipulator is increased or decreased. When the gravity of the manipulator is greater than the buoyancy, the manipulator descends or does not move at the water bottom. When the buoyancy is greater than the gravity, the manipulator moves upwards. When the limiting mooring rope 6 is straightened, under action of traction force of the limiting mooring cable 6, the manipulator is maintained at a certain horizontal height. The amount of gas filled into the expansion ball body 4 is controlled according to the gravity of the manipulator, to control overall lifting of the manipulator.

Through further optimization solution, the mounting disc 1 includes an upper fixed disc 8 and a lower connecting disc 9 which are fixedly connected. The manipulator main body 2 and the expansion ball body 4 are fixedly connected with the upper fixed disc 8, and the gas pipe 5 and the limiting mooring rope 6 are fixedly connected with the lower connecting disc 9. The upper fixed disc 8 and the lower connecting disc 9 are connected through a fixed rod. A rotating shaft 10 is located between and rotatably connected with the upper fixed disc 8 and the lower connecting disc 9. The rotating shaft 10 is of a hollow structure, the fixed rod is arranged in the rotating shaft 10, and the rotating shaft 10 can rotate around the fixed rod. The driving part includes a driving shaft 11 and a propeller 12 fixedly arranged on the driving shaft 11, the driving shaft 11 penetrates through the rotating shaft 10 and is parallel to the upper fixed disc 8, and the driving shaft 11 is driven by a first motor. The rotating shaft 10 is directly driven by a second motor to control directions of the driving shaft 11 and the propeller 12, and the first motor controls the driving shaft 11 to rotate so that the propeller 12 works normally. Under the action of the propeller 12, horizontal movement of the manipulator is achieved. During the horizontal movement process, due to the action of buoyancy, an advancing track of the manipulator is of an arc structure. Furthermore, under the action of the second motor, steering operation can be easily achieved. Furthermore, when water flow exists in the seabed and the water bottom, the influence of the water flow can be counteracted through micro rotation of the propeller 12, which ensures that the manipulator can stay at a certain position stably.

Through further optimization solution, connecting sleeves 13 are fixedly arranged between the manipulator main body 2 and the mounting disc 1, and the number of the connecting sleeves 13 is equal to that of the mechanical claws 3. The control part includes rotating rods 14 arranged in the connecting sleeves 13. An end of the rotating rod 14 is connected with a transmission shaft 15 through a bevel gear assembly, the transmission shaft 15 is perpendicular to the rotating rod 14, gear teeth are arranged on an outer side of the mechanical claw 3. Driving gears 19 matched with the gear teeth are rotatably connected with interiors of the connecting sleeves 13, and the driving gears 19 are in shaft connection with the transmission shafts 15. Driving motors and gear assemblies are arranged in the upper fixed disc 8. The numbers of the driving motors and the gear assemblies are predetermined according to needs. The rotating rods 14 are driven to rotate through the driving motors and the gear assemblies to bring the transmission shafts 15 into rotation, so that the driving gears 19 are driven to drive the mechanical claws 3 to rotate, the mechanical claws 3 slide in the manipulator main body 2 to achieve grabbing operation. Furthermore, the first motor can be driven to operate so that the mechanical claws start to move, thereby achieving dragging operation.

The manipulator main body 2 is of a horizontal semicircular cylinder structure, the mechanical claw 3 is of an arc-shaped structure matched with the semicircular cylinder structure of the manipulator main body 2, no less than two mechanical claws 3 are arranged on two sides of the interior of the manipulator main body 2 respectively, and the connecting sleeves 13 are arranged on two sides of the exterior of the manipulator main body 2. Two ends of the semicircular cylinder of the manipulator main body 2 are detachably connected with end plates 20 matched with the semicircular cylinder structure, a limiting plate 16 is arranged on an outer side of each end plate 20, and a hydraulic cylinder 17 is provided between and connected with the limiting plate 16 and the mounting disc 1. When a sealing structure needs to be formed, two mechanical claws 3 are provided, lengths of the mechanical claws 3 are equal to that of the manipulator main body 2, the mechanical claws 3 and the mechanical arm body 2 form a cylinder after the mechanical claws 3 are folded, and ends of the cylinder are sealed through the limiting plates 16 and the end plates 20. When the manipulator grabs approximately cylindrical structures such as cables, the end plates 20 on the two sides are dismounted, so that objects can be grabbed by the cylinder formed by the folded mechanical claws 3 and the manipulator main body 2.

Through further optimization solution, an elastic limiting net 18 is arranged between each mechanical claw 3 and the manipulator main body 2, one end of the elastic limiting net 18 is arranged at the highest end of the mechanical claw 3, and the other end of the elastic limiting net 18 is fixedly arranged in the manipulator main body 2. The elastic limiting net 18 can move along with the movement of the mechanical claw 3. Under the action of elasticity, the elastic limiting net 18 is lengthened and wraps the objects, which can be adapted for objects of different shapes and achieve secondary fixing.

### Embodiment Two

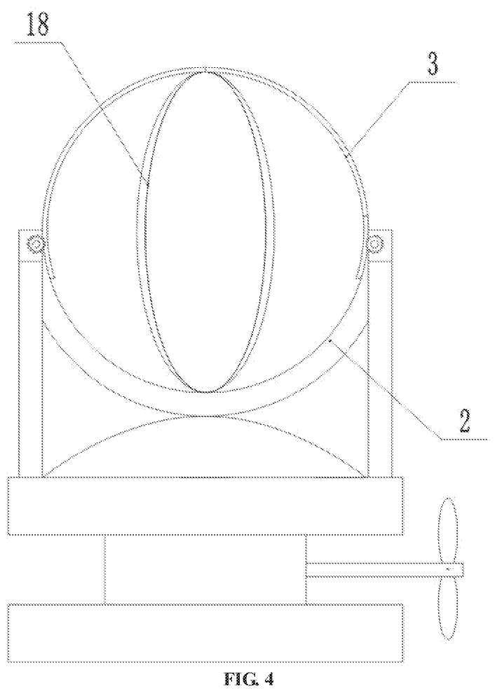

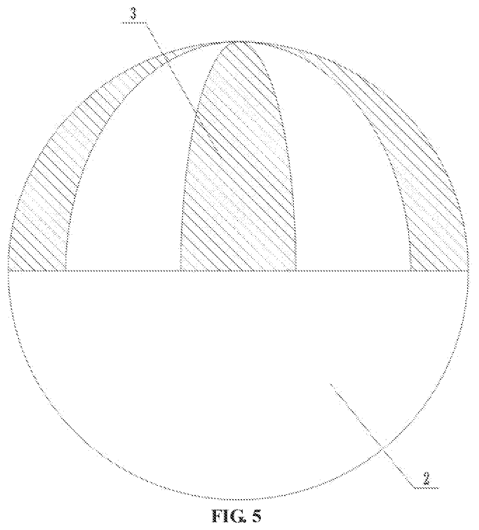

Referring to FIG. 4 and FIG. 5, this embodiment provides an underwater manipulator. The difference between this embodiment and Embodiment One lies in that the manipulator main body 2 is of a hollow hemispherical structure, the mechanical claw 3 is of a three-dimensional arc-shaped structure matched with the hollow hemispherical structure of the manipulator main body 2, and this embodiment is suitable for grabbing objects similar to spherical structures.

Through further optimization solution, the three-dimensional arc-shaped structure of the mechanical claw 3 is of a three-point type structure, a first end point of the mechanical claw 3 is arranged on the uppermost portion of the mechanical claw 3, and a second end point and a third end point of the mechanical claw 3 are both arranged on the lowermost portion of the mechanical claw and located on the same horizontal line, the three-dimensional arc-shaped structure is similar to decorative patterns on watermelon. No less than three mechanical claws 3 are arranged, and the distances between every two adjacent mechanical claws are the same. The objects are limited in multiple directions through the multiple mechanical claws 3. Furthermore, the elastic limiting net 18 can move along with the movement of the mechanical claw 3. Under the action of elasticity, the elastic limiting net 18 is lengthened and wraps the objects, and can be adapted for objects of different shapes and achieve secondary fixing.

In the description of the present disclosure, it needs to be understood that the indicative direction or position relations of the terms such as “longitudinal”, “transverse”, “upper”, “lower”, “front”, “rear”, “left”, “right”, “vertical”, “horizontal”, “top”, “bottom”, “inside” and “outside” are direction or position relations illustrated based on the accompanying drawings, just for facilitating the description of the present disclosure, but not for indicating or hinting that the indicated device or element must be in a specific direction and is constructed and operated in the specific direction, the terms cannot be understood as the restriction of the present disclosure.

The embodiments described above only describe the preferred manner of the present disclosure and do not limit the scope of the present disclosure, and various modifications and improvements made to the technical solution of the present disclosure by those skilled in the art will fall within the scope of protection as determined by the claims of the present disclosure without departing from the spirit of the design of the present disclosure.

1. An underwater manipulator, comprising:
a mounting disc connected with a lifting part configured for controlling the mounting disc to ascend and descend, and a driving part configured for controlling the mounting disc to move horizontally;
a manipulator main body fixedly arranged on a side of the mounting disc; and
a plurality of mechanical claws slidably connected with an interior of the manipulator main body, wherein each mechanical claw is controlled by a control part to rotate;
wherein the lifting part comprises an expansion ball body fixedly connected with the mounting disc, the expansion ball body is communicated with a gas pipe, the gas pipe is fixedly connected with a limiting mooring rope, and an end of the gas pipe and an end of the limiting mooring rope are connected with a water ship body or an underwater robot; and
wherein connecting sleeves are fixedly arranged between the manipulator main body and the mounting disc, a number of the connecting sleeves is equal to that of the plurality of mechanical claws; the control part comprises rotating rods arranged in the connecting sleeves, an end of each rotating rod is connected with a transmission shaft through a bevel gear assembly, the transmission shaft is perpendicular to the rotating rod, gear teeth are arranged on outer sides of the mechanical claws, driving gears matched with the gear teeth are rotatably connected with interiors of the connecting sleeves, and the driving gears are in shaft connection with the transmission shafts.

2. The underwater manipulator according to claim 1, wherein the mounting disc comprises an upper fixed disc and a lower connecting disc which are fixedly connected, the manipulator main body and the expansion ball body are fixedly connected with the upper fixed disc, and the gas pipe and the limiting mooring rope are fixedly connected with the lower connecting disc.

3. The underwater manipulator according to claim 2, wherein the upper fixed disc and the lower connecting disc are connected through a fixed rod.

4. The underwater manipulator according to claim 3, wherein a rotating shaft is rotatably connected between the upper fixed disc and the lower connecting disc, the driving part comprises a driving shaft and a propeller fixedly arranged on the driving shaft, the driving shaft penetrates through the rotating shaft and is parallel to the upper fixed disc, and the driving shaft is driven by a first motor; and the rotating shaft is of a hollow structure, the fixed rod is arranged in the rotating shaft, and the rotating shaft rotates around the fixed rod.

5. The underwater manipulator according to claim 1, wherein the manipulator main body is of a horizontal semicircular cylinder structure, each mechanical claw is of an arc-shaped structure matched with the semicircular cylinder structure of the manipulator main body, at least two mechanical claws are provided on two sides of the interior of the manipulator main body respectively, and the connecting sleeves are arranged on two sides of an exterior of the manipulator main body.

6. The underwater manipulator according to claim 5, wherein two ends of the manipulator main body are detachably connected with end plates matched with the semicircular cylinder structure of the manipulator main body, a limiting plate is arranged on an outer side of each end plate, and a hydraulic cylinder is connected between the limiting plate and the mounting disc.

7. The underwater manipulator according to claim 1, wherein the manipulator main body is of a hollow hemispherical structure, and each mechanical claw is of a three-dimensional arc-shaped structure matched with the hollow hemispherical structure of the manipulator main body.

8. The underwater manipulator according to claim 7, wherein the three-dimensional arc-shaped structure of the mechanical claw is of a three-point type structure, a first end point of the mechanical claw is arranged on an uppermost portion of the mechanical claw, and a second end point and a third end point of the mechanical claw are arranged on a lowermost portion of the mechanical claw and located on a same horizontal line; and at least three mechanical claws are provided and distances between every two adjacent mechanical claws are equal one another.

9. The underwater manipulator according to claim 1, wherein an elastic limiting net is arranged between each mechanical claw and the manipulator main body, an end of the elastic limiting net is provided at a highest end of the mechanical claw, and another end of the elastic limiting net is fixedly provided in the manipulator main body.
